(19) United States
(12) Patent Application Publication
(10) Pub. No.: US 2010/0241488 A1
(43) Pub. Date: Sep. 23, 2010

(54) Educational website

(76) Inventor: Alan Jacobson, Norfolk, VA (US)

Correspondence Address: LITMAN LAW OFFICES, LTD., POST OFFICE BOX 41200, SOUTH STATION, ARLINGTON, VA, 22204, US

(21) Appl. No.: 12/659,411

(22) Filed: Mar. 8, 2010

Related U.S. Application Data
(60) Provisional application No. 61/202,652, filed on Mar. 23, 2009.

(51) Int. Cl. G06Q 99/00; G09B 5/00; G06Q 30/00; G06Q 50/00; G06Q 10/00; H04W 4/00

(52) U.S. Cl. 705/10; 434/350; 705/14.52; 455/466

(57) ABSTRACT

The educational website is a web-driven social network that aggregates content from other sites, the content being of interest to a niche category of users. The website registers site users while collecting demographic and geographic information associated with each user. Customized user permissions over the website are allocated based on the demographic and geographic information collected. The website serves the aggregated content on at least one web page accessible to a user's display device. Advertising is delivered to the users based on the user demographic information, geographic information and permissions. In one particular embodiment, the website aggregates news items. Students and teachers are registered. The website accepts student posted comments and reviews about the news items. Advertising is targeted to the students and teachers based on their demographic and geographic information. Advertisements can be categorized as display or print and delivered to the users accordingly.

### CROSS-REFERENCE TO RELATED APPLICATION

This application claims the benefit of U.S. Provisional Patent Application Ser. No. 61/202,652, filed Mar. 23, 2009.

### BACKGROUND OF THE INVENTION

1. Field of the Invention

The present invention relates generally to Internet community networks and advertising methods, and particularly to an educational website that incorporates features relating to teaching children that also includes advertising features.

2. Description of the Related Art

A Tween is a pre-adolescent human being of approximately between the ages of 9 and 12. Tweens have a keen interest in reading news, writing news, and commenting about the news. It would be desirable to provide a platform from which the tweens may fulfill their keen interest in the news. Additionally, it would be desirable to get tweens to visit such a website while, at the same time, providing an advertising engine capable of profitably funding the website.

Moreover, it would be desirable to publish content of interest to any niche category of users, obtain location and demographic information about such users, subcategorize the users based on the geographic, demographic and user data, and then push advertisements to the users based on their subcategories.

Thus, an educational website solving the aforementioned problems is desired.

### SUMMARY OF THE INVENTION

The educational website is a web-driven social network that aggregates content from and links to other sites, thereby transforming the educational website into a website having content of interest to a niche category of users. The website registers site users while collecting demographic and geographic information associated with each user. The niche category of users is divided into subcategories based on information obtained via the registration step, the demographic information collection step, and the geographic information collection step. User permissions are customized over the website and are allocated based on the user subcategories. The website serves the aggregated content on at least one web page accessible to a user's display device. Advertising is delivered to the users based on the user subcategories, which may also include a user's Internet Protocol Address (IP Address).

In one particular embodiment, the website aggregates news items of special interest to students. Students and teachers are registered. Teachers are assigned to a teacher subcategory and given teacher permissions to view and use the website. Similarly, students are assigned to a student subcategory and given student permissions to view and use the website. The website accepts student-posted comments and reviews about the news items. Teachers can view and use a teacher's lounge web page, edit student comments, post entries in the lounge, and the like. Students do not have the required permissions to access the teacher's lounge portion of the website, nor can they edit other students' comments. Advertising is targeted to the students and teachers based on their subcategory. Advertisements are divided into display advertisements and print advertisements. Only print advertisements can be sent to a printer for hardcopy distribution.

These and other features of the present invention will become readily apparent upon further review of the following specification and drawings.

### BRIEF DESCRIPTION OF THE DRAWINGS

FIG. 1 is a block diagram of a system for providing an educational website according to the present invention.

FIG. 2 is a flowchart showing steps in demographic/geographic based registration and access to information served on the educational website according to the present invention.

FIG. 3 is a flowchart showing steps in selecting content to appear on web pages of the educational website according to the present invention.

FIG. 4 is a screenshot showing a representative homepage for an educational website according to the present invention.

FIG. 5 is a screenshot showing an exemplary article index page on an educational website, according to the present invention.

FIG. 6 is a screenshot showing an exemplary class registration page for an educational website according to the present invention.

FIG. 7 is a screenshot showing a representative user registration page for an educational website according to the present invention.

FIG. 8 is a screenshot showing an exemplary faculty lounge page for an educational website according to the present invention.

FIG. 9 is a screenshot showing a “stories class may comment upon” page of the educational website, according to the present invention.

FIG. 10 is a screenshot showing an exemplary “my class comments page” of an educational website according to the present invention.

FIG. 11 is a partial screenshot showing an exemplary “comments awaiting approval” page of the educational website according to the present invention.

FIG. 12 is a screenshot showing details of an exemplary “comments awaiting approval” page of the educational website according to the present invention.

FIG. 13 is a partial screenshot showing a “published comments” page of the educational website according to the present invention.

FIG. 14 is a screenshot showing details of an exemplary “published comments” page of the educational website, according to the present invention.

FIG. 15 is an exemplary printout or report page of the educational website according to the present invention.

FIG. 16 is a screenshot showing an exemplary “get headlines via text” page of the educational website according to the present invention.

Similar reference characters denote corresponding features consistently throughout the attached drawings.

### DETAILED DESCRIPTION OF THE PREFERRED EMBODIMENTS

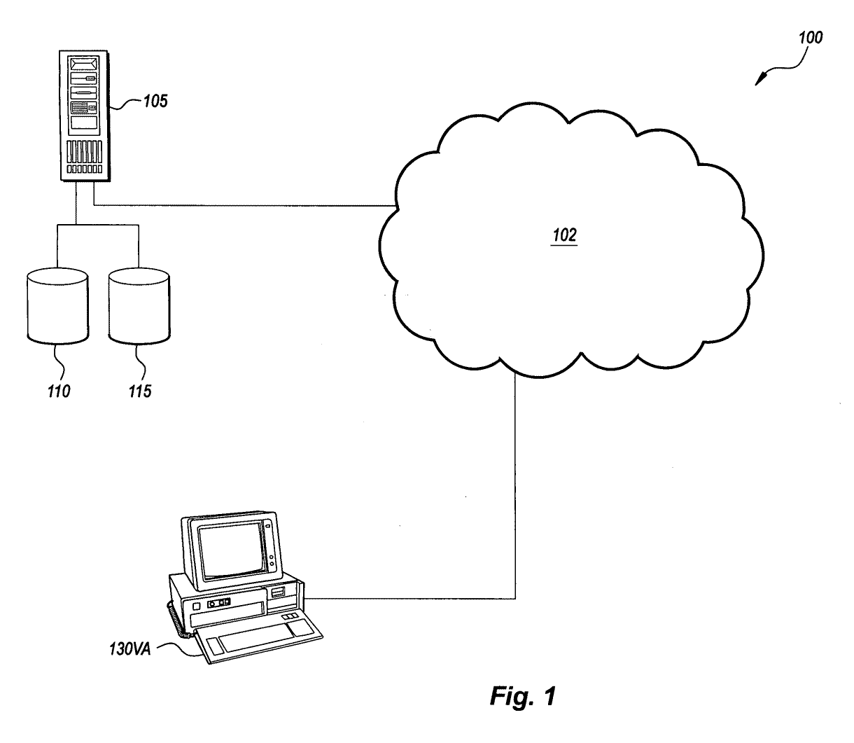

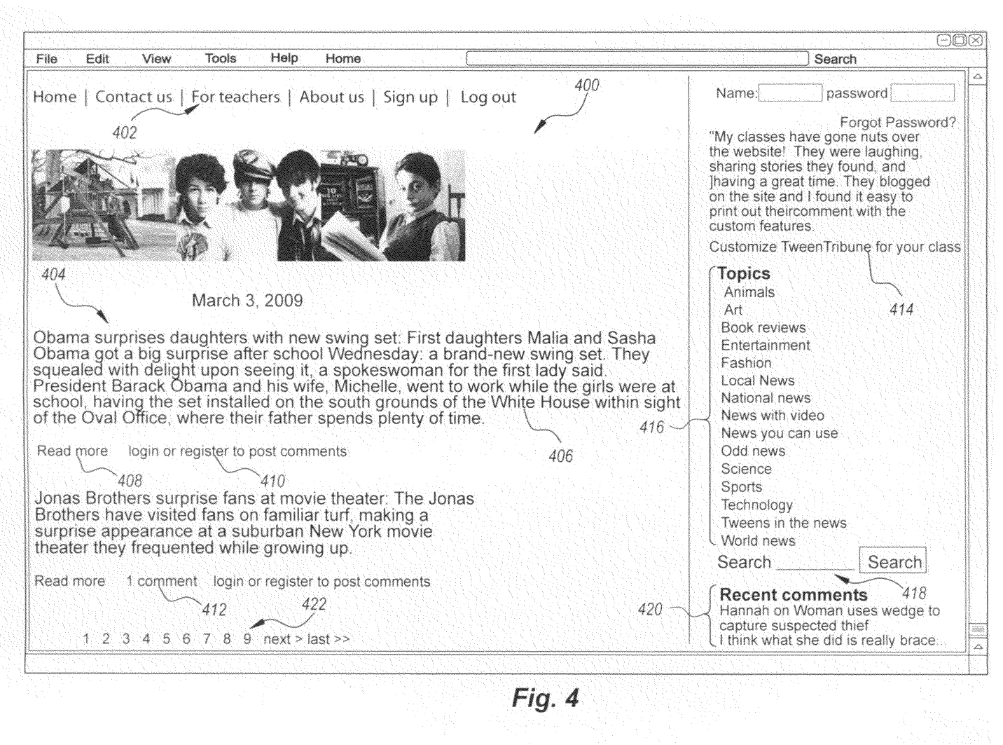

As shown in FIGS. 1 and 4, the present invention relates to a website having a first page exemplified by home page 400, the website being delivered over computing network system 100 and providing a web-driven social network that aggregates content from other sites. A niche aggregator model is provided in that the website aggregates content from, and/or links to other sites, thereby transforming the educational website into a website having content of interest to a niche category of users.

Computers within the system 100 may be interoperable via the Internet 102. For example, the web server 105 may provide the educational website while making the website viewable to user devices 120CO, 120VA 122, 130VA, and 130CO via the Internet 102. Connectivity via the Internet 102 allows the web server 105 to disseminate the educational website to users having disparate locations. For example, user device 120CO could be associated with a student in a Colorado classroom; user device 120VA could be associated with a student in a Virginia classroom; user device 130CO could be associated with a teacher in a Colorado classroom; and user device 130VA could be associated with a teacher in a Virginia classroom; while user device 122 could be associated with an unspecified user in an unspecified locale.

Programmed instructions executable by the web server 105 for serving web page content, and the web page content itself, may be stored in web content/advertisements data storage device 110. Options are available through which the system 100 may aggregate content for a specific audience by hand, or alternatively, by an autobot or feed engine. The aggregation method includes combing through a plurality of sites, e.g., hundreds of sites periodically, e.g., each day to find stories that meet satisfaction criteria that satisfy the interests of a target niche audience, e.g., the exemplary Tween audience discussed herein.

The stories that are found based on the satisfaction criteria are then organized for presentation on the website. The news stories may be selected for publication on the website as a means of improving students' academic skills in areas such as, but not limited to, language arts, social studies and computer skills. Moreover, the website provides interactivity via means for the audience members to comment on the news items provided. Within this description and the following claims it should be understood that the term “educational” describing the website is construed in the broadest sense in that the website content is informational and does not necessarily have to be of interest to students or teachers, but could be of interest to any number of categories and subcategories of niche users, such as, without limitation, vacationers, travelers, tradesmen/women, professionals, hobbyists, sports enthusiasts, a particular group of IP addresses, a specific IP address, and the like.

The website registers site users while collecting demographic and geographic information associated with each user. For example, students and teachers are registered. The demographic, geographic and user information is stored in user type/geo/demo data storage device 115. Customized user permissions over the website are allocated based on the demographic and geographic information collected. The website serves the aggregated content on at least one web page accessible to a user's display device, e.g., to user device 122.

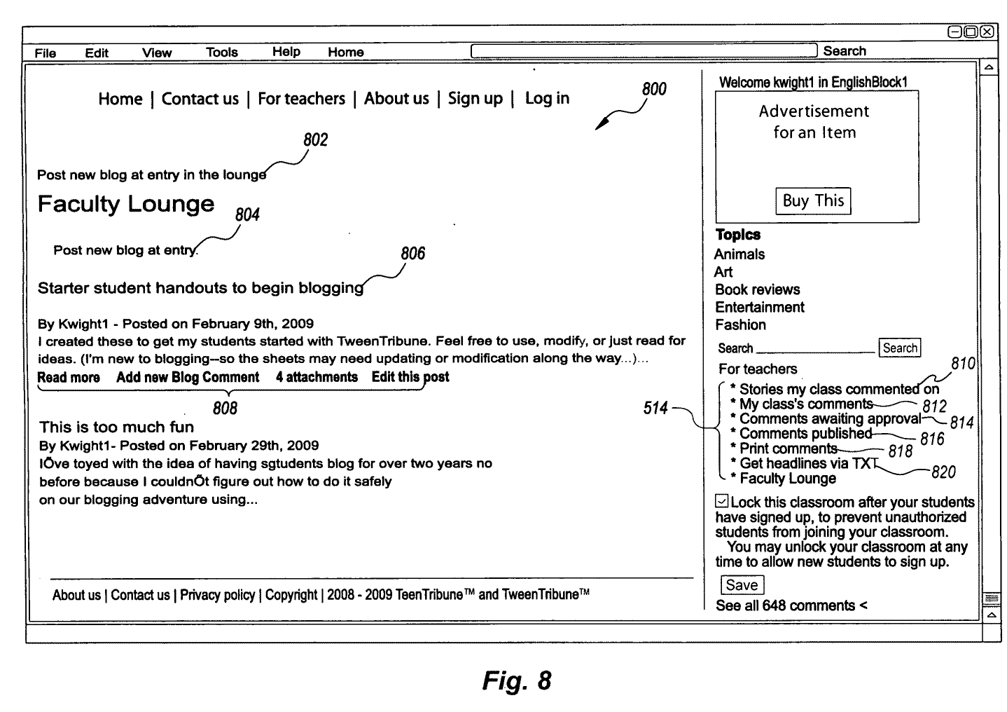

Advertising is delivered to the users based on the user demographic information, geographic information and permissions. In one particular embodiment, the website aggregates news items of special interest to students and formats the news items in the form of hypertext links 404 and informational text 406 for display on a user's computing device. Students and teachers are registered. Teachers are assigned to a teacher subcategory and given teacher permissions to view and use the website. Similarly, students are assigned to a student subcategory and given student permissions to view and use the website. The website accepts student posted comments and reviews about the news items. As shown in FIG. 8, teachers can view and use a faculty lounge web page 800, edit student comments, post entries in the lounge, and the like. Students do not have the required permissions to access the faculty lounge page 800 of the website, nor can they edit other students' comments. Advertising is targeted to the students and teachers based on their subcategory. Ads are targeted geographically and demographically with 100 percent accuracy because all subcategories of users are registered with their associated geographic and demographic information. Moreover, Ads can be served up on the Internet, via email, and via Short Messaging Services (SMS), the modality of delivery being dependent upon the user's subcategory classification. Advertisements are divided into display advertisements, e.g., 504a and print advertisements, e.g., 505b. Advantageously, the system 100 formats advertisers' messages in proximity to content links and comments on the educational website. The advertisers' messages can be geo-targeted based on the profile of the user. The user is required to submit this geo-based data before her or she can post comments. Only print advertisements can be sent to a printer for hardcopy distribution. The educational website can be custom tailored to appeal to a select age demographic. For example, at least 10 age-appropriate stories could be posted daily that, Tweens (age group 9-13) will find compelling, relevant, and useful. The system 100 allows users to post comments, but mechanisms are provided for review of the posts to make sure they don't compromise young people's safety. When providing content for young people, the system 100 is easily made compliant with the Children's Online Privacy Protection Act (COPPA), as outlined by the Federal Trade Commission (FTC). The system 100 provides a means through which kids can send in news stories, and tags each story with video and/or links to all stories that contain video. The system 100 provides an information source for kids who are tasked with a current events project.

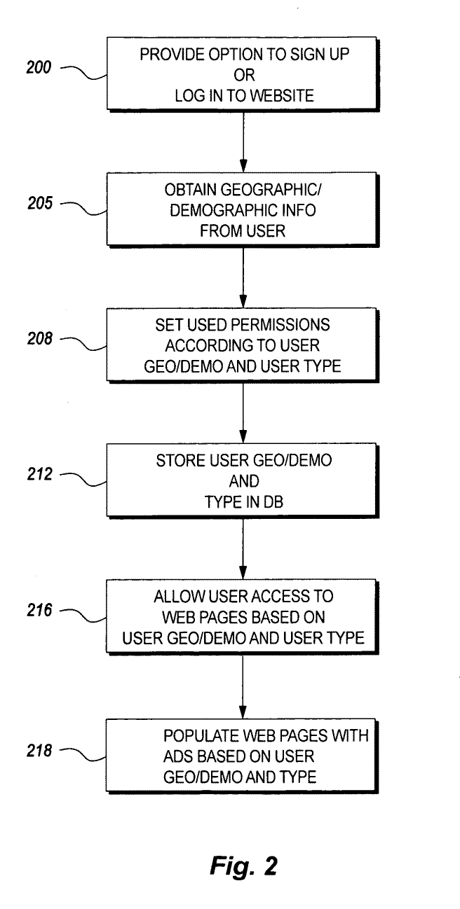

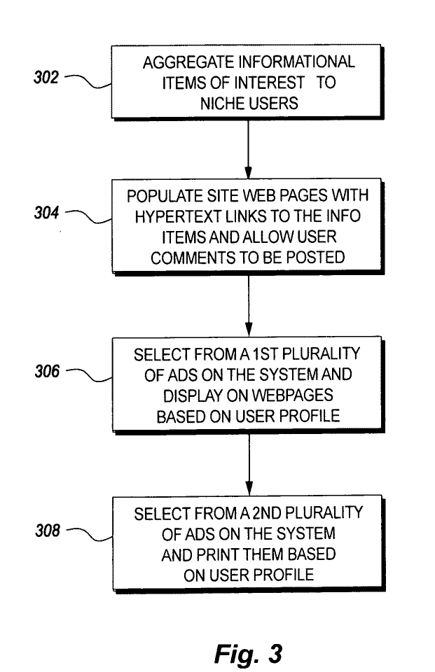

The logic flow executable by web server 105 is summarized in FIGS. 2-3. As shown in FIG. 2, at step 200, an option is provided to sign up or log into the inventive educational website. At step 205 the geographic and demographic information is obtained from the user. At step 208 user permissions are set according to the user geographic, demographic, and user type information. At step 212 the user data, geographic and demographic data are stored in a database accessible to the server 105. At step 216 users are allowed to access web pages served via web server 105 based on the user subcategories, i.e., based on the user, geographic and demographic types. At step 218, the server populates web pages with advertisements based on who is viewing the web pages, according to user sub category defined by user type, geographic information associated with the user, and demographic information associated with the user. As shown in FIG. 3, the website is transformed to engage a niche category of users. At step 302, information of interest to a niche category of users is aggregated from other websites. At step 304, the inventive website is populated with hypertext links to the aggregated information items and at least one subcategory (profile) of users is permitted to post comments regarding the information. At step 306, based on a first user profile, a first plurality of advertisements on the system 100 is selected and displayed on web pages accessible to users having the first user profile. Additionally, at step 308, based on a second user profile, a second plurality of advertisements on the system 100 is selected and accessible via printout to users having the second user profile. As an example, first and second pluralities of advertisements may be different in type in that the first plurality of advertisements may be display Ads available for observation via a user's display device, while the second plurality of advertisements may be print Ads, available for observation via a printout (hardcopy) which the user can order.

As shown in FIG. 4, Navigation links 402 are provided at the top of most of the web pages, including home page 400. A “Read more” link 408 is provided that links to additional information about the story. The user may post a comment about the story via the “login/register to post” links 410. The system 100 provides a convenient means for users to view/edit their own comments. A user may also view comments (and related stories) of other users, e.g., his/her peer group. The system 100 provides the posting capability as a means for encouraging students posting comments on news stories to improve their academic skills in areas such as, but not limited to, language arts, social studies and computer skills. Stories that already have at least one comment include a comment link 412 that when clicked activates a comment page (for viewing the comment(s)). Thus, one-click functionality is provided so that students can see their own comments, or their classmates' comments, collected on a single page. A plurality of web pages may be populated with the news items and are accessible via page links 422 at the bottom of the page. A customization link 414 is provided on the right hand side of the page. News topics may be selected via a group of topics hypertext links 416. The website pages may be searched via entry of search criteria in search field 418. Recent comments 420 are also displayed on the home page 400.

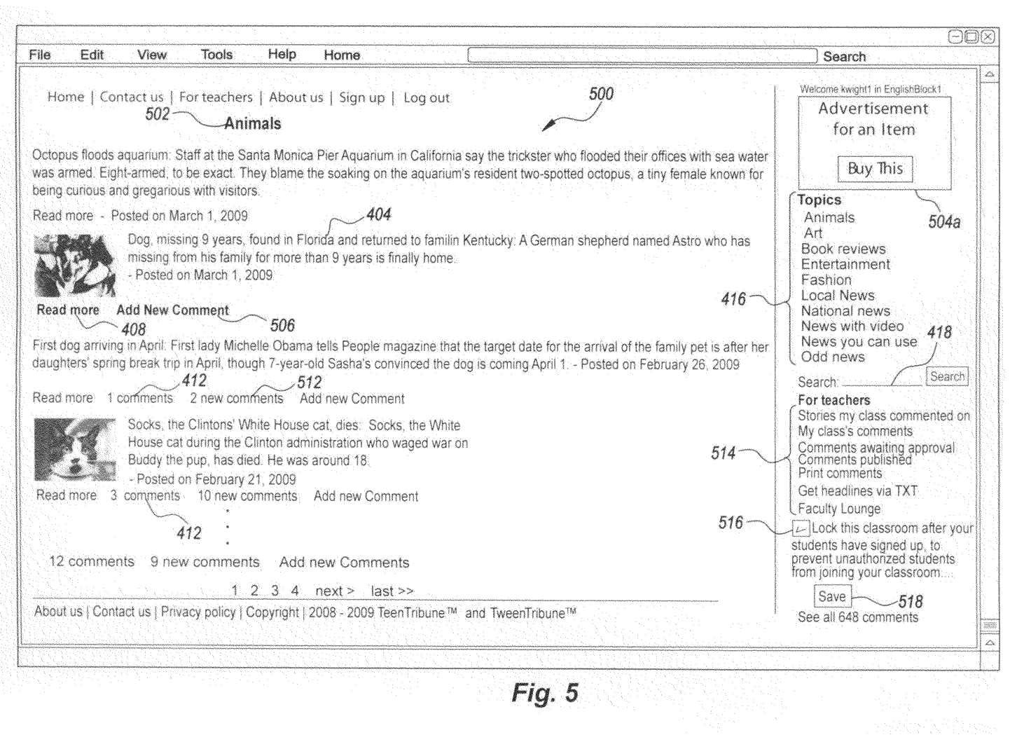

An exemplary topic page 500 is shown in FIG. 5. The topic header 502 identifies which topic was selected via the topics hypertext links 416. The website accepts student posted comments and reviews about the news items. An “Add New Comment” link is provided proximate the text associated with news item 404. If new comments have been posted, they are accessible via “New comments” link 512. Advertisements can be categorized as display only or print only and delivered to the users accordingly. An exemplary display advertisement 504a is presented on the right hand side of the page just above topics links 416. Advertising is targeted to the students and teachers based on their user, demographic and geographic information, i.e., user subcategory. The inventive website only displays the ad 504a to a registered user having the demographics and locale specified in user type/geo/demo database 115. Links may be reserved for a distinct subcategory of users. For example, Teacher links 514 are reserved for teachers only, the access policy being mediated via server 105 in conjunction with user type/geo/demo database 115. The classroom lock 516 is provided to prevent additional registration of students to the site for a particular teacher/classroom. The classroom lock configuration can be saved via pressing Save button 518.

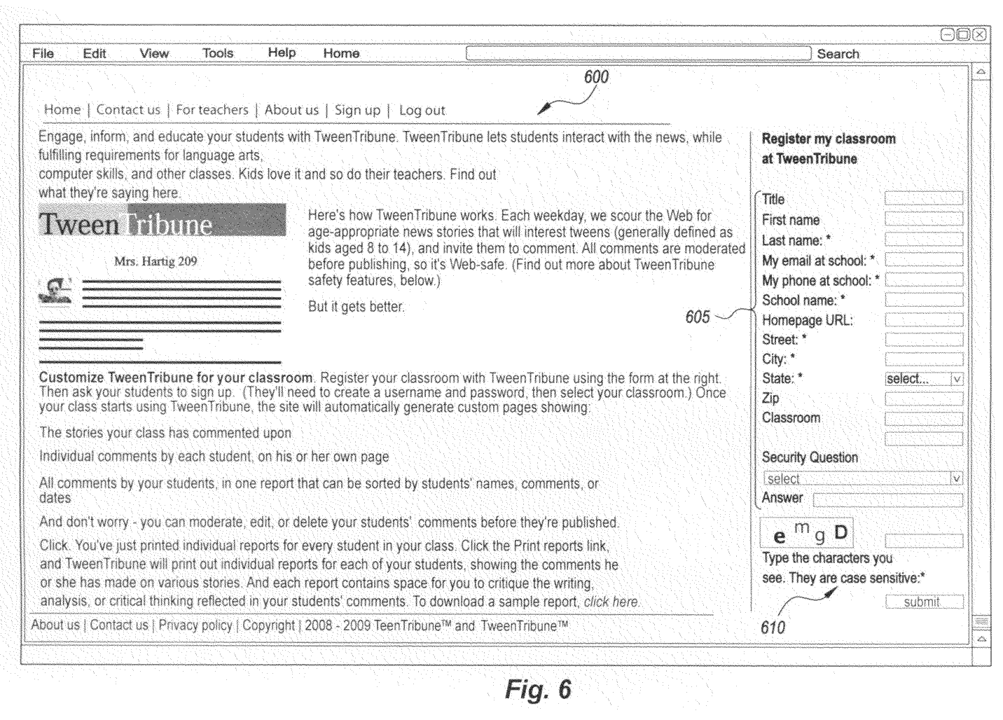

As shown in FIG. 6, a classroom registration page 600 is available from which a teacher can register his/her classroom on the educational website. The registration fields 605 must be filled out to successfully register the classroom. It should be noted that a Capcha™ code 610 is presented and the registrant must successfully enter the code in the field provided to authenticate the classroom registration.

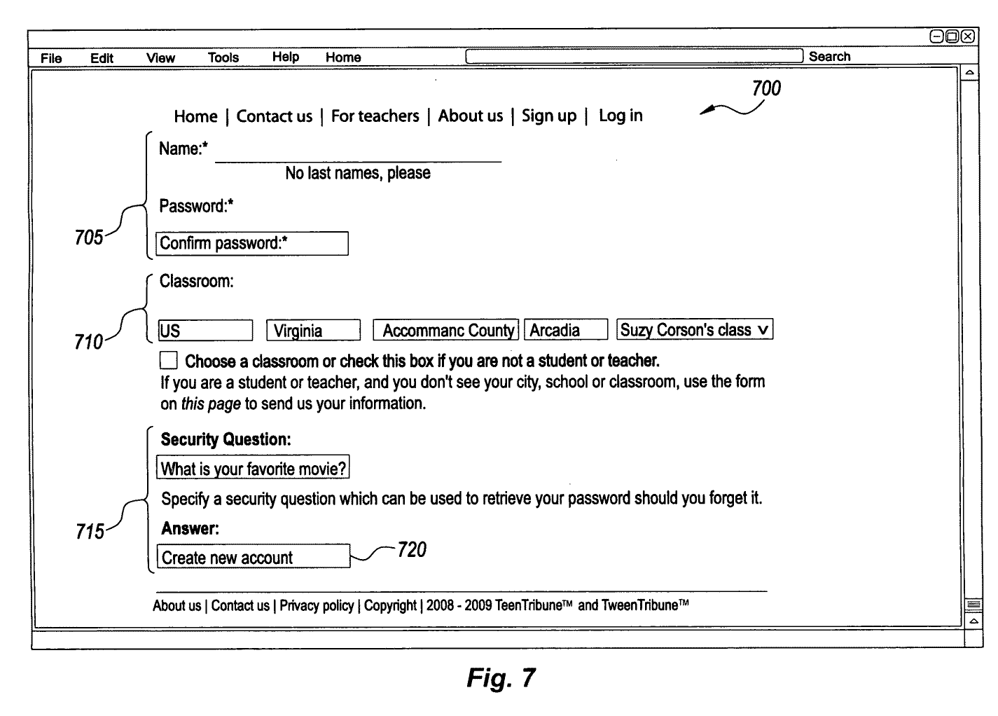

Each student can enter a unique user name (usually the student's first name, or first name and last initial) and a password of his or her choice. To protect privacy, last names and student e-mail addresses are prohibited by the system 100. Then the student will select the classroom of the teacher offering the join invitation from a series of dropdown menus, beginning with state and drilling down to the specific classroom. As shown in FIG. 7, a user registration page 700 is available from which any user can register on the educational website. User registration fields 705 must be filled out by the registrant. Classroom select pulldowns 710 are available for student registrants. Registration pulldowns 710 include the location of the student's school, which should be selected to further identify the demographics of the registering student. Security question and answer fields 715 should be filled out to enable capability of the server 105 to retrieve a forgotten password. “Create new acct” pushbutton 720 completes the registration process when clicked on by the user.

As shown in FIG. 8, a faculty lounge page 800 is provided exclusively for the users who are teachers. A teacher may post a lounge entry via lounge entry link 802 or post a new blog entry via link 804. A typical faculty lounge entry hypertext link 806 can be clicked on to display detail of the entry. Teachers may perform various operations on the entries via read add get attachments edit links 808. The attachments link provides a convenient means for teachers to share lesson plans, etc. “For Teachers” links group 514 is subdivided into “stories my class commented on” 810, “my classes comments” 812, “comments awaiting approval” 814, “comments published” 816, “print comments” 818, and “get headlines via txt” 820.

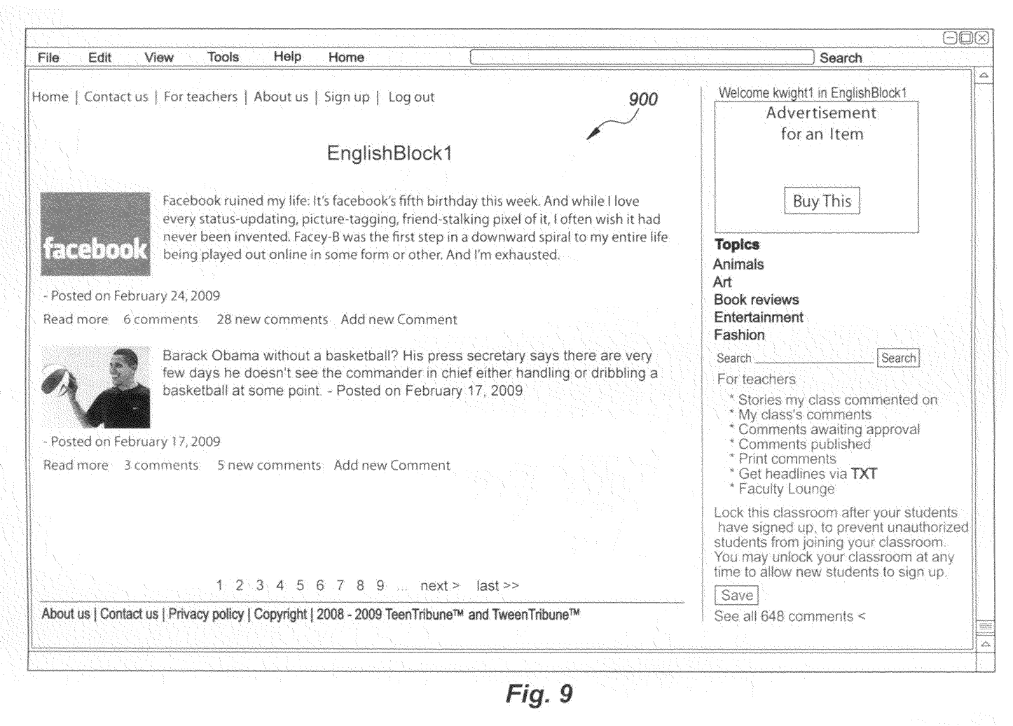

As shown in FIG. 9 a “stories my class commented on” page 900 can be displayed to show the stories that students associated with a registered classroom have commented on.

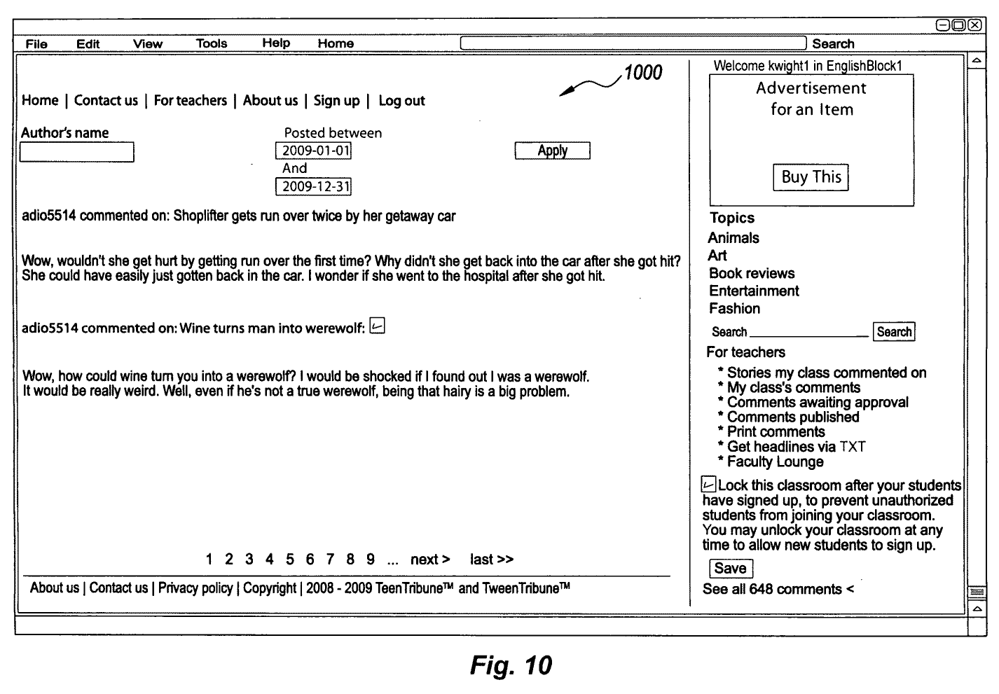

As shown in FIG. 10, a “my class comments” page 1000 can be displayed to show the comments of a class associated with the site registered teacher who is logged in and viewing the page.

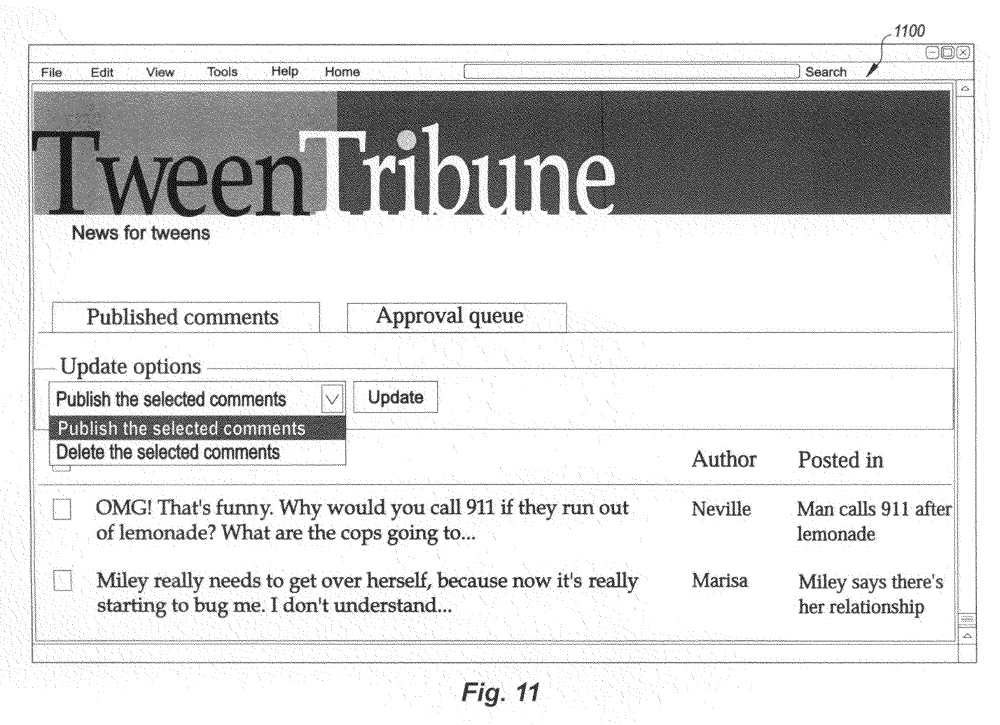

As shown in FIG. 11, a “comments awaiting approval” page 1100 can be displayed to show a queue of class comments awaiting approval by the site registered teacher who is logged in and reviewing comments on the page before the comments are published to the Internet from the site.

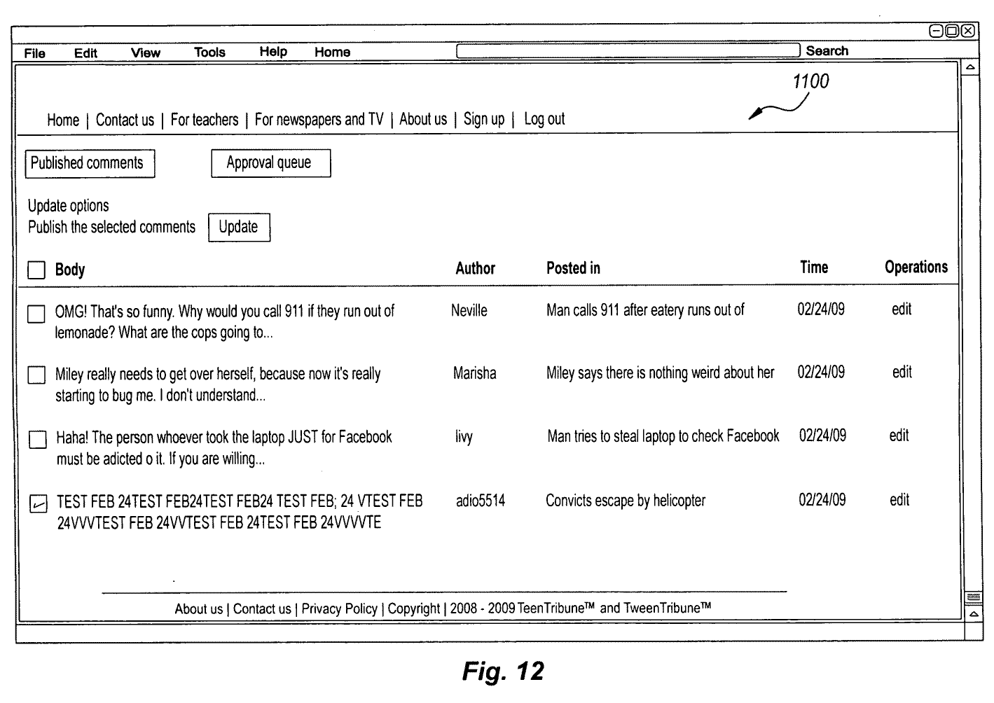

As shown in FIG. 12, details of the “comments awaiting approval” page 1100 reveal columns that indicate “comment body”, “Author”, “Story posted in”, “Time of Post”, and an Edit link for editing the comment. Selected comments can be edited, published, removed, or the like.

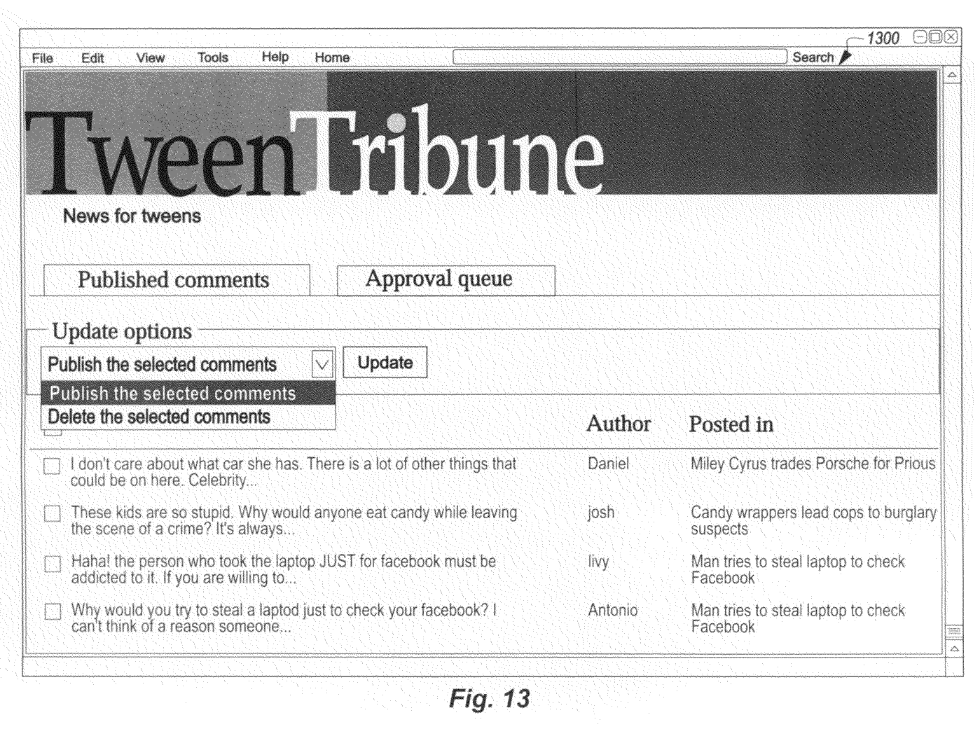

As shown in FIG. 13, a published comments page 1300 can be viewed by the teacher. Selected comments can be unpublished and/or deleted. Thus, the system 100 provides a convenient means for teachers to moderate, publish, edit and delete comments posted by students.

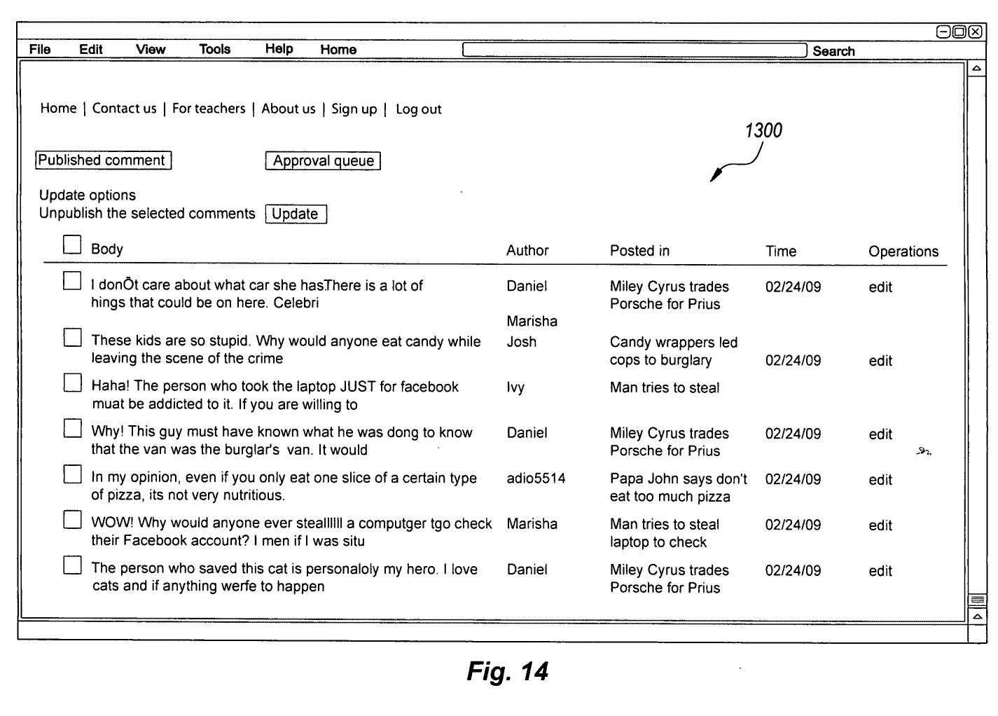

As shown in FIG. 14, details of the “published comments” page 1300 include comment body, author, posted in, time of post, and an edit operation button.

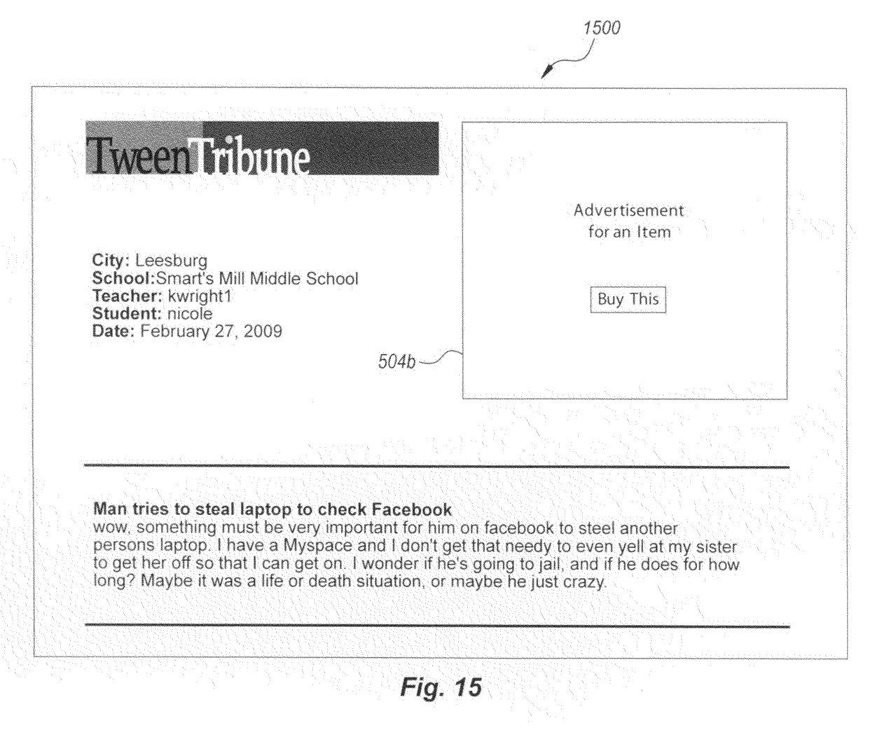

As shown in FIG. 15, a report, i.e., printout page 1500 is a hardcopy and may include an advertisement 504b that is available only via the hardcopy printout. A separate report on each student may be created and printed for the purpose of tracking and grading each student's academic performance, since for each comment the report prints out an identification of the locale, school, teacher, student, and date. When the teacher prints out the reports on each student, the ads appear on each page of each report on each student. The system 100 provides space adjacent to each printed comment so a teacher may add an evaluation, critique or grade. It should be understood that print advertisement 504b is thus targeted to a specific locale, school, teacher and class. Additional filters could target a specific student in the class.

Media companies are encouraged to sell advertising space on the website, since the media companies are made aware of the fact that the website serves advertisements which can be geographically targeted to a student's profile (e.g. the location of the student's school). The system 100 partners with schools, assuring media companies that their advertising dollar is well spent, thereby more readily funding the educational website.

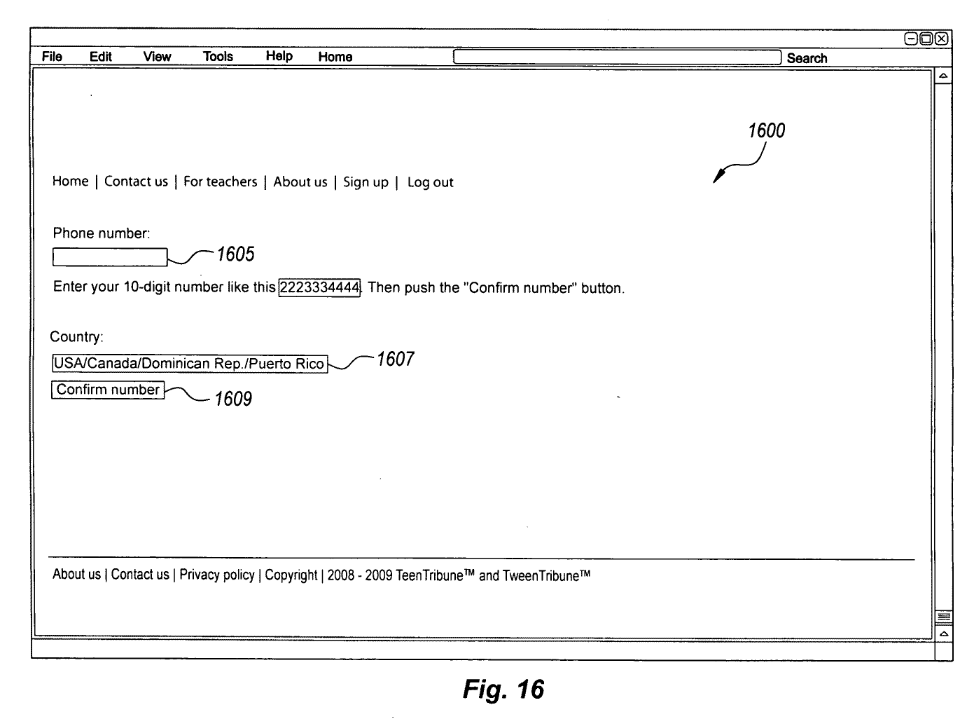

As shown in FIG. 16, a “get headlines via text” page 1600 can be displayed and enables a user to get headlines via a text message sent to the user's mobile communications device, e.g., to a cell phone. A phone number entry field 1605 is presented. A country entry field 1607 is presented. A confirm number pushbutton 1609 can be selected by the user after filling out the aforementioned fields.

It is important to note that while the educational website has been described in the context of a fully functioning data processing system including web server 105 having program storage devices 110 and 115, those of ordinary skill in the art will appreciate that the processes of the website are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, USB drives, CD-ROMs and transmission-type media, such as digital and analog communications links.

It is to be understood that the present invention is not limited to the embodiment described above, but encompasses any and all embodiments within the scope of the following claims.

I claim:

1. A computer-implemented educational website method, comprising the steps of:
establishing a website on a computer network, the website aggregating content from and linking to other websites, the content being of interest to a target niche category of users, thereby transforming the website to an educational website of interest to the target niche category of users;
registering each of the users on the website;
collecting demographic information associated with each of the users;
collecting geographic information associated with each user;
dividing the target niche category of users into subcategories based on information obtained via the registration step, the demographic information collection step, and the geographic information collection step;
publishing the aggregated content for display on a user accessible display device; and
delivering advertising to the users, the advertising delivered to each of the respective users being dependent upon which of the subcategories the respective user has been assigned to.

2. The computer-implemented educational website method according to claim 1, wherein the content aggregation is performed automatically.

3. The computer-implemented educational website method according to claim 1, further comprising the step of using satisfaction criteria associated with said target niche category of users to discover content for aggregation on said website.

4. The computer-implemented educational website method according to claim 1, wherein said advertising delivery step includes selecting from among webpage, email, and SMS modes of advertising delivery depending upon a user's subcategory classification.

5. The computer-implemented educational website method according to claim 1, wherein said advertisements are divided into display advertisements and print advertisements, only said print advertisements being sent to a printer for hardcopy distribution.

6. The computer-implemented educational website method according to claim 1, wherein said advertising is posted in proximity to content links and comments on the educational website.

7. The computer-implemented educational website method according to claim 1, further comprising the step of geo-targeting said advertising based on said geographic information associated with said each user.

8. The computer-implemented educational website method according to claim 1, wherein said website is custom designed to appeal to a selected age demographic.

9. The computer-implemented educational website method according to claim 1, further comprising the steps of:
permitting a first subcategory of users to submit comments regarding said aggregated content for posting of said comments on said website, said comments not actually posting to said website until approved by a second subcategory of users.

10. The computer-implemented educational website method according to claim 1, further comprising the step of setting access permission to links on said website based on said subcategories of users.

11. The computer-implemented educational website method according to claim 10, wherein a first of said subcategories is a student subcategory and a second of said subcategories is a teacher subcategory.

12. The computer-implemented educational website method according to claim 11, further comprising the step of dividing said target niche category of users into groups of students and teachers based on school district, school and classroom location.

13. The computer-implemented educational website method according to claim 12, further comprising the step of providing a faculty lounge page on said website, said faculty lounge page being accessible exclusively to the users who are teachers.

14. The computer-implemented educational website method according to claim 13, further comprising the steps of:
allowing said teachers to post blogs to the faculty lounge page;
allowing said teachers to link and share lesson plans to the faculty lounge page;
allowing said teachers to approve and edit comments that students have posted regarding said web content;
allowing said teachers to create and print academic reports on said students; and
printing an advertisement on each page of each of said academic reports.

15. The computer-implemented educational website method according to claim 14, further comprising the steps of:
displaying a “get headlines via text” page that enables a user to get headlines via a text message sent to the user's mobile communications device;
accepting a user entered phone number for delivery of said text message; and
delivering said text message to a communication device associated with said user entered phone number.

16. A computer software product, comprising a medium readable by a processor, the medium having stored thereon a set of instructions for establishing and publishing an educational website on a computer network, the set of instructions including:
(a) a first sequence of instructions which, when executed by the processor, causes said processor to establish a website aggregating content from and linking to other websites, the content being of interest to a target niche category of users, thereby transforming the website to an educational website of interest to the target niche category of users;
(b) a second sequence of instructions which, when executed by the processor, causes said processor to register each of the users on the website;
(c) a third sequence of instructions which, when executed by the processor, causes said processor to collect demographic information associated with each of the users;
(d) a fourth sequence of instructions which, when executed by the processor, causes said processor to collect geographic information associated with each of the users;
(e) a fifth sequence of instructions which, when executed by the processor, causes said processor to divide the target niche category of users into subcategories based on information obtained via the second, third, and fourth sequences of instructions;
(f) a sixth sequence of instructions which, when executed by the processor, causes said processor to publish the aggregated content for display on a user accessible display device; and
(g) a seventh sequence of instructions which, when executed by the processor, causes said processor to deliver advertising to each of the respective users via web pages on the website, the advertising delivered being dependent upon which of the subcategories the respective user has been assigned to.

17. The computer software product according to claim 16, wherein the set of instructions further comprises an eighth sequence of instructions which, when executed by the processor, causes said processor to use satisfaction criteria associated with said target niche category of users to discover content for aggregation on said website.

18. The computer software product according to claim 16, wherein the set of instructions further comprises a ninth sequence of instructions which, when executed by the processor, causes said processor to separate display advertisements from print advertisements, and send only said print advertisements to a printer for hardcopy distribution.

19. The computer software product according to claim 16, wherein the set of instructions further comprises a tenth sequence of instructions which, when executed by the processor, causes said processor to accept comment submissions for posting on said website from a first subcategory of users, said comment submissions regarding said aggregated content, said comments not actually being posted to said website until approved by a second subcategory of users.

20. The computer software product according to claim 16, wherein the set of instructions further comprises an eleventh sequence of instructions which, when executed by the processor, causes said processor to set access permission to links on said website based on said subcategories of users.
